(19) United States
(12) Patent Application Publication
(10) Pub. No.: US 2005/0174033 A1
(43) Pub. Date: Aug. 11, 2005

(54) Color cathode-ray tube

(75) Inventor: Takayuki Shimamura, Kobe-shi (JP)

Correspondence Address: MERCHANT & GOULD PC, P.O. BOX 2903, MINNEAPOLIS, MN, 55402-0903, US

(73) Assignee: Matsushita Toshiba Picture Display Co., Ltd., Takatsuki-shi (JP)

(21) Appl. No.: 11/038,609

(22) Filed: Jan. 18, 2005

(30) Foreign Application Priority Data
Feb. 10, 2004 (JP) 2004-033893

(51) Int. Cl. H01J 29/80; H01J 29/07; H01J 29/81

(52) U.S. Cl. 313/404; 313/406; 313/407

(57) ABSTRACT

A shadow mask structure is held on a panel via a support member in which a base member and a spring member are connected to each other in a substantially V-shape. The spring member includes a connecting portion connected to the base member, an engagement portion having an engagement hole in which a stud pin is fitted, and an elastic portion between the connecting portion and the engagement portion, tilted with respect to the base member and mainly having a spring function. Assuming that a width of an end of the elastic portion on the connecting portion side is A, a width of an end of the elastic portion on the engagement portion side is B, a width of a narrowest part of the elastic portion in a region including both the ends is C, and a minimum value of an effective width of the elastic portion in the region including both the ends is C′, relationships: A>C and B>C, and 0.40<C′/A<0.55 are satisfied. Because of this, the plastic deformation of the spring member under the application of an external impact thereto can be reduced, so that color displacement on a screen attributable to mislanding can be reduced.

### BACKGROUND OF THE INVENTION

1. Field of the Invention

The present invention relates to a color cathode-ray tube.

2. Description of the Related Art

When a color cathode-ray tube is operated, an electron beam strikes a shadow mask (color selection electrode), and the shadow mask and a frame holding the shadow mask expand thermally, whereby an aperture on the shadow mask moves slightly toward a circumferential edge of the shadow mask. Consequently, the relative position between the aperture and a phosphor surface formed on a panel is changed and causes color displacement on a screen. In order to correct the color displacement, a support mechanism for fixing the shadow mask to the panel generally is provided with a function of correcting a change in position of the aperture of the shadow mask.

As the support mechanism, a substantially V-shaped support mechanism has been used conventionally. During thermal expansion of the shadow mask and the like, a spring member of the substantially V-shaped support mechanism is deformed so that the shadow mask approaches the phosphor surface side. Therefore, color displacement attributable to a change in position of the aperture of the shadow mask can be prevented. Furthermore, there is no problem that the shadow mask is rotated, for example, as in the case of using an elongated plate-shaped spring composed of two kinds of metals called a bimetal spring.

However, the substantially V-shaped support mechanism is likely to be deformed or to come off a stud pin when an external impact attributable to dropping or the like is applied to a cathode-ray tube, compared with the bimetal spring. In order to solve this problem, an attempt has been made to improve the material for the spring member (e.g., see JP6(1994)-44916A).

Recently, in a color cathode-ray tube, a panel on which an image is to be displayed is flattened since the flat panel reduces the reflection of external light and enhances the appearance. Along with this, as a shadow mask having a function of color selection, the one welded to a frame under the application of tension has come into use in place of a press-type shadow mask. A shadow mask structure provided with such a so-called tension-type shadow mask has a large weight so as to maintain the mechanical strength required for withstanding a tensile strength. Thus, there is a problem that sufficient strength against an external impact cannot be ensured merely by improving the material for the spring member. In particular, when an external impact is applied in a direction parallel to a long side direction of a screen, the spring member is likely to be deformed plastically. When the spring member is deformed plastically, the relative position between the aperture of the shadow mask and the phosphor surface is changed and causes color displacement.

### SUMMARY OF THE INVENTION

Therefore, with the foregoing in mind, it is an object of the present invention to provide a color cathode-ray tube excellent in impact resistance.

In order to achieve the above-mentioned object, a color cathode-ray tube of the present invention includes: a panel in which a phosphor surface is formed on an inner surface and a stud pin is fixed; a funnel connected to the panel; a shadow mask structure placed so as to be opposed to the phosphor surface; and a support mechanism for engaging the shadow mask structure with the stud pin. The support mechanism includes a base member and a spring member connected to each other in a substantially V-shape. The spring member includes a connecting portion connected to the base member, an engagement portion having an engagement hole in which the stud pin is fitted, and an elastic portion between the connecting portion and the engagement portion, tilted with respect to the base member and mainly having a spring function. Assuming that a width of an end of the elastic portion on the connecting portion side is A, a width of an end of the elastic portion on the engagement portion side is B, a width of a narrowest part of the elastic portion in a region including both the ends is C, and a minimum value of an effective width of the elastic portion in the region including both the ends is C′, relationships: A>C and B≧C, and 0.40<C′/A<0.55 are satisfied.

These and other advantages of the present invention will become apparent to those skilled in the art upon reading and understanding the following detailed description with reference to the accompanying figures.

### BRIEF DESCRIPTION OF THE DRAWINGS

FIG. 1 is a schematic cross-sectional view of a color cathode-ray tube according to Embodiment 1 of the present invention.

FIG. 2A is an enlarged front view of a support mechanism of the color cathode-ray tube according to Embodiment 1 of the present invention, and FIG. 2B is an enlarged side view thereof

FIG. 3 is a diagram showing the amount of a change in landing position of an electron beam when a drop impact test is performed with a width ratio C/A of an elastic portion of the support mechanism varied.

FIG. 4 is an enlarged front view of a support mechanism of a color cathode-ray tube according to Embodiment 3 of the present invention.

FIG. 5 is an enlarged front view of a support mechanism of a color cathode-ray tube according to Embodiment 4 of the present invention.

FIG. 6A is an enlarged front view of a support mechanism of a color cathode-ray tube according to Embodiment 5 of the present invention, and FIG. 6B is an enlarged side view thereof.

FIG. 7 is an enlarged front view of a support mechanism of a color cathode-ray tube according to Embodiment 6 of the present invention.

### DESCRIPTION OF THE PREFERRED EMBODIMENTS

According to the present invention, when an external impact is applied, a stress applied to the elastic portion of the spring member is dispersed. Therefore, the plastic deformation of the spring member can be reduced, and consequently, color displacement on a screen that occurs due to mislanding can be reduced. Thus, a color cathode-ray tube excellent in impact resistance can be provided.

In the above-mentioned color cathode-ray tube of the present invention, it is preferable that a relationship: B>C is satisfied. More specifically, it is preferable that the elastic portion includes a narrowest part at a position excluding the end on the connecting portion side and the end on the engagement portion side. According to this configuration, in the course of producing the color cathode-ray tube, the workability in attaching or detaching the shadow mask structure to the panel is enhanced.

Furthermore, it is preferable that, in a state where the shadow mask structure is mounted on the panel, a flexural height D of the elastic portion of the spring member is 12.5 mm or more. According to this configuration, the impact force applied to the spring member under the application of an external impact to the color cathode-ray tube can be decreased further, so that the plastic deformation of the spring member can be reduced further. Thus, the impact resistance of the color cathode-ray tube is enhanced further.

Hereinafter, the present invention will be described by way of illustrative embodiments with reference to the drawings.

### Embodiment 1

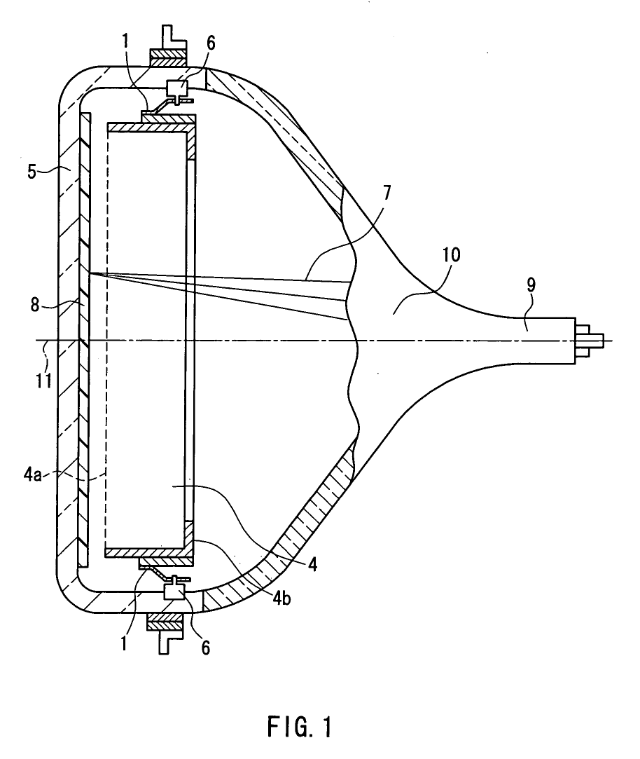

FIG. 1 is a schematic cross-sectional view of a color cathode-ray tube according to Embodiment 1 of the present invention. The color cathode-ray tube of the present embodiment includes an envelope composed of a panel 5 and a funnel 10 connected to each other. An outer surface of an image display region of the panel 5 is substantially flat. On an inner surface of the panel 5, a phosphor surface 8 is formed. Reference numeral 4 denotes a shadow mask structure that is composed of a shadow mask 4a on which a number of apertures are formed and a substantially rectangular frame 4b supporting the shadow mask 4a while applying tension thereto. Support mechanisms 1 are attached to four corners of the frame 4b, and a stud pin 6 fixed on an inner surface of the panel 5 is fitted in and engaged with an engagement hole provided in each support mechanism 1, whereby the shadow mask structure 4 is fixed to the panel 5. An electron gun (not shown) is provided in a neck portion 9 of the funnel 10, and electron beams 7 emitted from the electron gun pass through the apertures of the shadow mask 4a and illuminate the phosphor surface 8 of the panel 5, whereby an image is displayed on a screen of the color cathode-ray tube. Reference numeral 11 denotes a tube axis that passes through substantially the center of the color cathode-ray tube.

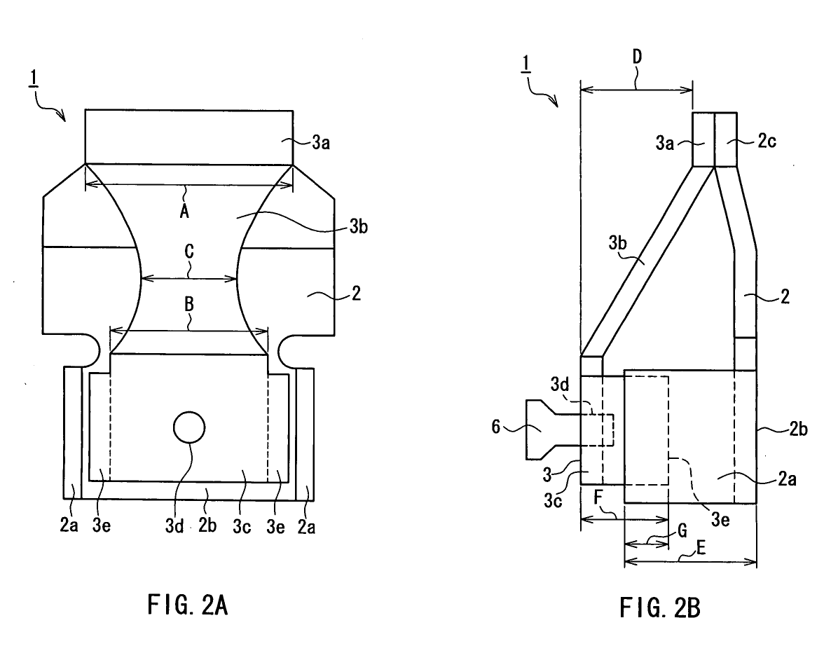

FIG. 2A shows an enlarged front view of the support mechanism 1 in the color cathode-ray tube of the present embodiment, and FIG. 2B shows an enlarged side view thereof. The support mechanism 1 is composed of a base member 2 and a spring member 3. The base member 2 includes a base portion 2b welded to the frame 4b, a pair of guide portions 2a formed so as to be connected to the base portion 2b and bent substantially vertically with respect to the base portion 2b, and a connecting portion 2c welded to the spring member 3. The spring member 3 is composed of a connecting portion 3a attached to the connecting portion 2c of the base member 2, an elastic portion 3b tilted with respect to the base portion 2b and mainly having a spring function, an engagement portion 3c having an engagement hole 3d in which the stud pin 6 is to be fitted, and a pair of guide portions 3e formed so as to be bent vertically with respect to the engagement portion 3c. As shown in FIG. 2B, the base member 2 and the spring member 3 are connected to each other so as to have a substantially V-shape when seen as a whole, due to the tilt of the elastic portion 3b with respect to the base portion 2b.

The pair of guide portions 3e of the spring member 3 are placed between the pair of guide portions 2a of the base member 2, and at least a part of the guide portion 2a is opposed to at least a part of the guide portion 3e. By providing the guide portions 2a, 3e, when an external impact is applied to the color cathode-ray tube, the guide portion 2a and the guide portion 3e interfere with each other, whereby the stress applied to the spring member 3 (in particular, the elastic portion 3b) can be reduced. Therefore, the amount of elastic deformation of the spring member 3 can be reduced, and consequently, the amount of color displacement of the color cathode-ray tube can be reduced.

As shown in FIG. 2A, assuming that a width of an end of the elastic portion 3b on the connecting portion 3a side is A, a width of an end of the elastic portion 3b on the engagement portion 3c side is B, and a width of a narrowest part of the elastic portion 3b in a region including both the ends is C, relationships: A>C and B≧C are satisfied. More specifically, the width of the elastic portion 3b is maximum at the end on the connecting portion 3a side.

Preferably, as shown in FIG. 2A, a relationship: B>C is satisfied. More specifically, the elastic portion 3b has a part narrower than both the ends at an intermediate position. Thus, it is preferable that the elastic portion 3b of the spring member 3 has a constricted shape in which both edges in a width direction are curved in a concave shape.

The function of the support mechanism 1 will be described by way of an example. The color cathode-ray tube used herein had a diagonal size of a screen of 36 inches (86 cm). The pitch in a horizontal direction of the apertures hereinafter, referred to as an “aperture pitch”) of the shadow mask 4a was 0.58 mm. The frame 4b of the shadow mask structure 4 had a size of 50 mm in a tube axis direction, and the thickness of the members was 1.8 mm. The total weight of the shadow mask structure 4 was 4 kg. Such a color cathode-ray tube was subjected to a drop impact test.

The color displacement allowance (allowable shift amount from a reference position of a spot position of an electron beam, at the center of an aperture-formed region of the shadow mask) of the color cathode-ray tube with an aperture pitch of 0.58 mm is about 40 μm. This allowance includes the allowance of landing position deviation of an electron beam attributable to thermal expansion and geomagnetism, as well as the allowance of landing position deviation of an electron beam attributable to the mask position deviation caused by an external impact. Herein, the allowance of position deviation caused by an external impact is preferably less than 20 μm, and more preferably 15 μm or less. The main factor causing the color displacement with an external impact is plastic deformation of the spring member 3.

The drop impact test was performed by applying an impact of a maximum acceleration of 20G parallel to a long side direction of a screen to the color cathode-ray tube, and measuring the amount of a change in landing position of an electron beam at the center of the screen before and after the application of the impact.

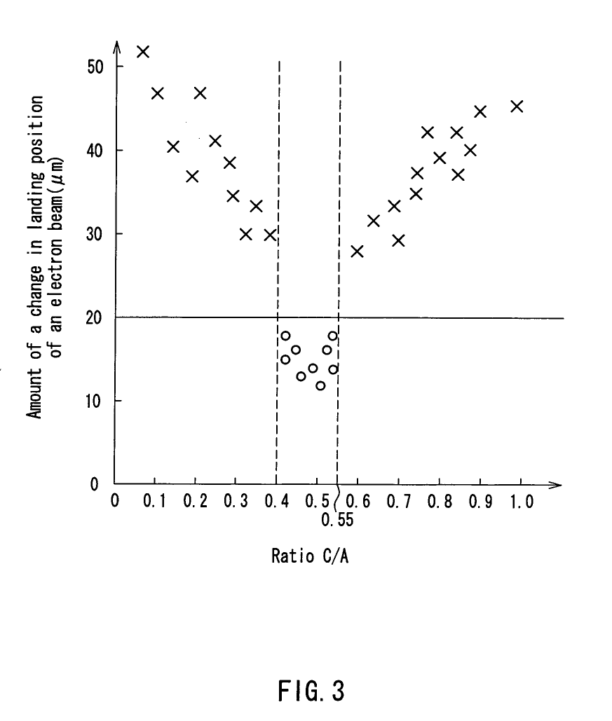

Regarding the support mechanism 1 used, as shown in FIG. 2B, a height E of the guide portion 2a of the base member 2 was set to be 10 mm, a height F of the guide portion 3e of the spring member 3 was set to be 5 mm, and an overlap amount G in a height direction between the guide portion 2a of the base member 2 and the guide portion 3e of the spring member 3 (n a stationary state where the shadow mask structure 4 was mounted on the panel 5) was set to be 4 mm. As the overlap amount G becomes larger, it is more advantageous to an external impact. However, when the height E of the guide portion 2a exceeds 10 mm, the guide portion 2a is likely to damage an inner wall of the panel 5 when the shadow mask structure 4 is attached or detached with respect to the stud pins 6 in the course of producing the color cathode-ray tube. Furthermore, when the height F of the guide portion 3e exceeds 5 mm, the guide portion 3a and the base portion 2b are likely to bump into each other when the shadow mask structure 4 is attached or detached with respect to the stud pins 6, which makes it difficult to attach or detach the shadow mask structure 4. Color cathode-ray tubes were produced in such a manner that the widths A, B, and C of the spring member 3 satisfied the relationships: A>C and B≧C, with the ratio C/A varied, and each color cathode-ray tube was subjected to a drop impact test. FIG. 3 shows the results.

The following is understood from FIG. 3. In the case where the ratio C/A satisfies a relationship: 0.40<C/A<0.55 (represented by a symbol “∘” in FIG. 3), the above-mentioned condition “the amount of a change in landing position of an electron beam caused by an external impact is less than 20 μm” is satisfied, and in the case where the ratio C/A is out of the above-mentioned numerical value range (represented by a symbol “x” in FIG. 3), the above condition is not satisfied.

The reason why the ratio C/A has a large effect on impact resistance is considered as follows. When an external impact is applied to the color cathode-ray tube, the stress caused by the external impact is applied to the spring member 3, in addition to the stress applied thereto in the stationary state. At this time, the elastic portion 3b is away from the engagement hole 3d that is to be a point of pressure, and a moment amount is increased, so that the elastic portion 3b is most likely to be deformed plastically. In the case where the ratio C/A≧0.55, that is, in the case where there is no large difference between the width A of the end of the elastic portion 3b on the connecting portion 3a side and the width C of the narrowest part of the elastic portion 3b, a stress is concentrated on the end of the elastic portion 3b on the connecting portion 3a side, whereby the elastic portion 3b is deformed plastically. Furthermore, in the case where the ratio C/A≦0.40, that is, in the case where the width C of the narrowest part of the elastic portion 3b is extremely smaller than the width A of the end of the elastic portion 3b on the connecting portion 3a side, a stress is concentrated in the narrowest part, whereby the elastic portion 3b is deformed plastically. Thus, in the case where the relationship: 0.40<C/A<0.55 is satisfied, the stress added to be applied to the elastic portion 3b due to the external impact can be dispersed, and the plastic deformation of the elastic portion 3b can be reduced.

### Embodiment 2

Embodiment 2 is the same as Embodiment 1, except that a flexural height D of the elastic portion 3b of the spring member 3 is 12.5 mm or more. Herein, the flexural height D refers to a displacement amount of the connecting portion 3a with respect to the engagement portion 3c in a direction normal to the principal plane of the engagement portion 3c in a stationary state where the shadow mask structure 4 is mounted on the panel 5 as shown in FIG. 2B.

A drop impact test was performed with the flexural height D of the elastic portion 3b varied. Consequently, in the case where the flexural height D was 12.5 mm or more, the amount of a change in landing position was reduced by about 5 μm on average, compared with the case where the flexural height D was less than 12.5 mm.

By setting the flexural height D of the elastic portion 3b to be 12.5 mm or more, the torsional rigidity of the spring member 3 is reduced. Therefore, the impact force applied to the spring member 3 under the application of an external impact to the color cathode-ray tube can be reduced, and consequently, the amount of plastic deformation of the spring member 3 can be reduced further.

### Embodiment 3

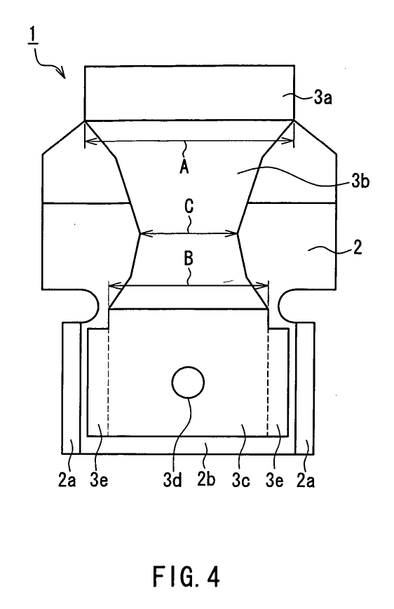

Embodiment 3 is different from Embodiment 1 in the following point. In Embodiment 3, as shown in FIG. 4, both edges in a width direction of the elastic portion 3b of the spring member 3 are composed of a plurality of straight lines connected to each other at a predetermined angle, whereas in Embodiment 1, both the edges in the width direction are composed of a smoothly curved line.

The present embodiment is the same as Embodiment 1 except for the above, and has the same effect as that of Embodiment 1.

### Embodiment 4

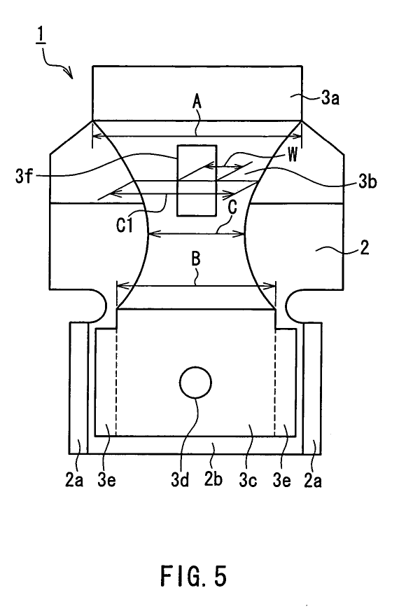

Embodiment 4 is different from Embodiment 1 in that a hole 3f is provided in the elastic portion 3b as shown in FIG. 5.

When the hole 3f is provided in the elastic portion 3b, the mechanical characteristics such as rigidity of the elastic portion 3b are changed. Thus, the effective width of the elastic portion 3b in view of the size of the hole 3f is considered. That is, as shown in FIG. 5, assuming that the external size (interval between both the edges in the width direction) of the elastic portion 3b is C₁ and the width of the hole 3f at that point is W, the effective width of the elastic portion 3b is defined by C₁−W. At the point where the hole 3f is not formed, W=0, so that the effective width of the elastic portion 3b is matched with the external size C₁.

In the case where the hole 3f is provided in the elastic portion 3b as in the present embodiment, assuming that the minimum value of the external size of the elastic portion 3b (i.e., the width in the narrowest part) is C, and the minimum value of the effective width of the elastic portion 3b is C′, it is necessary that relationships: A>C and B≧C and 0.40<C′/A<0.55 are satisfied. It is preferable that the relationship: B>C is satisfied, as shown in FIG. 5.

In the case where the hole 3f is not formed as in the elastic portion 3b described in Embodiment 1 (W=0), a relationship: C′=C is satisfied. Therefore, it is necessary that the relationships: A>C and B≧C and 0.40<C/A<0.55 are satisfied, as described in Embodiment 1.

### Embodiment 5

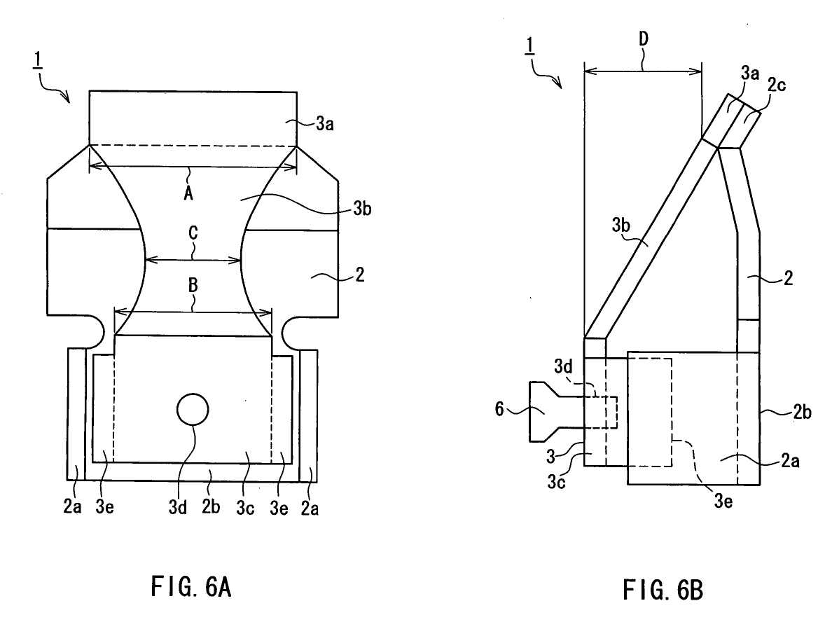

Embodiment 4 is different from Embodiment 1 in the following point. In Embodiment 4, as shown in FIGS. 6A and 6B, the connecting portion 3a and the elastic portion 3b of the spring member 3 are substantially co-planar, whereas in Embodiment 1, the elastic portion 3b is bent with respect to the connecting portion 3a.

In the present embodiment, a part of the spring member 3 in contact with the base member 2 is determined to be the connecting portion 3a, and a part of the spring member 3 not in contact with the base member 2 is determined to be the elastic portion 3b. Under this condition, the width A of the end of the elastic portion 3b on the connecting portion 3a side is determined. In the present embodiment, the widths A, B, and C satisfy the condition described in Embodiment 1, whereby the same effect as that described in Embodiment 1 is exhibited.

### Embodiment 6

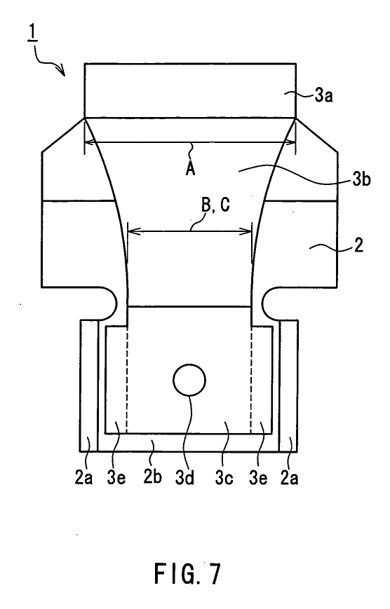

Embodiment 6 is different from Embodiment 1 in the following point. In Embodiment 6, as shown in FIG. 7, the narrowest part of the elastic portion 3b is placed at the end on the engagement portion 3c side, whereas in Embodiment 1, the narrowest part of the elastic portion 3b is placed in a region excluding the end on the connecting-portion 3a side and the end on the engagement portion 3c side. Thus, in the present embodiment, a relationship: B=C is satisfied.

As in the present embodiment, if the width of the elastic portion 3b is minimum at the end on the engagement portion 3c side, the stress added to be applied to the elastic portion 3b due to an external impact can be dispersed most satisfactorily, so that impact resistance is enhanced.

However, when the width of the elastic portion 3b is minimum at the end on the engagement portion 3c side, the following problem may arise. In the course of producing the color cathode-ray tube, when the shadow mask structure 4 is attached or detached with respect to the stud pins 6 fixed on the panel 5, the force toward the base portion 2b side is applied to the engagement portion 3c with a substantially U-shaped member, whereby the support mechanism 1 is deformed elastically. When the width of the elastic portion 3b is minimum on the engagement portion 3c side, the width of the engagement portion 3c also becomes narrow. Therefore, the substantially U-shaped member bumps into the circumferential end of the engagement portion 3c, and/or it becomes difficult to press the engagement portion 3c satisfactorily.

Thus, considering the workability in the course of producing the color cathode-ray tube, it is preferable that the relationship: B>C is satisfied as shown in FIG. 2A.

In the above-mentioned Embodiments 1 to 6, the case where the elastic portion 3b of the spring member 3 is a flat plate forming one plane has been described. As long as the base member 2 and the spring member 3 are connected to each other so as to form a substantially V-shape as a whole, for example, the elastic portion 3b may be bent at one or more places, and the elastic portion 3b may be curved in an arc shape.

Furthermore, the support mechanisms 1 are provided at four corners of the shadow mask structure 4. However, as long as the shadow mask structure 4 can be held stably, the support mechanism 1 may be provided at a place other than the four corners. Furthermore, the number of the support mechanisms 1 to be used is not limited to four.

As the color selection electrode, the example using the shadow mask has been described. However, for example, a so-called aperture grill having slit-shaped apertures also may be used.

Furthermore, the case where the shadow mask structure 4 with the shadow mask stretched in a flat plate shape so as to flatten a screen has been described. However, a shadow mask structure provided with a known shadow mask formed in a dome shape by pressing or the like may be used.

Furthermore, as the frame holding the shadow mask, the substantially rectangular frame is used. However, a frame may be used that is obtained by welding a long frame having a cross section in a triangular shape, an L-shape, or the like to a short frame having a cross section in a substantially U-shape or the like, in a substantially rectangular shape.

The applicable field of the color cathode-ray tube of the present invention is not particularly limited, and the color cathode-ray tube can be used for a TV receiver and a computer monitor.

The invention may be embodied in other forms without departing from the spirit or essential characteristics thereof The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

1. A color cathode-ray tube, comprising:
a panel in which a phosphor surface is formed on an inner surface and a stud pin is fixed;
a funnel connected to the panel;
a shadow mask structure placed so as to be opposed to the phosphor surface; and
a support mechanism for engaging the shadow mask structure with the stud pin,
wherein the support mechanism includes a base member and a spring member connected to each other in a substantially V-shape,
the spring member includes a connecting portion connected to the base member, an engagement portion having an engagement hole in which the stud pin is fitted, and an elastic portion between the connecting portion and the engagement portion, tilted with respect to the base member and mainly having a spring function, and
assuming that a width of an end of the elastic portion on the connecting portion side is A, a width of an end of the elastic portion on the engagement portion side is B, a width of a narrowest part of the elastic portion in a region including both the ends is C, and a minimum value of an effective width of the elastic portion in the region including both the ends is C′, relationships: A>C and B≧C, and 0.40<C′/A<0.55 are satisfied.

2. The color cathode-ray tube according to claim 1, wherein a relationship: B>C is satisfied.

3. The color cathode-ray tube according to claim 1, wherein, in a state where the shadow mask structure is mounted on the panel, a flexural height D of the elastic portion of the spring member is 12.5 mm or more.

4. The color cathode-ray tube according to claim 2, wherein, in a state where the shadow mask structure is mounted on the panel, a flexural height D of the elastic portion of the spring member is 12.5 mm or more.
